(19) United States
(12) Patent Application Publication
(10) Pub. No.: US 2017/0317982 A1
(43) Pub. Date: Nov. 2, 2017

(54) ELECTRONIC DEVICE WITH AN OPERATIONAL UNIT

(71) Applicant: KROHNE Messtechnik GmbH, Duisburg (DE)

(72) Inventor: Holger GLASMACHERS, Bochum (DE)

(73) Assignee: KROHNE Messtechnik GmbH, Duisburg (DE)

(21) Appl. No.: 15/582,829

(22) Filed: May 1, 2017

(30) Foreign Application Priority Data
Apr. 30, 2016 (DE) 10 2016 108 062.4
Aug. 30, 2016 (DE) 10 2016 116 152.7

(51) Int. Cl. H04L 29/06

(52) U.S. Cl. CPC H04L 63/04

(57) ABSTRACT

An electronic device has an operational unit for communication. The operational unit is provided with a first interface unit for secure communication and a second interface unit for insecure communication. To provide electronic devices, in which the manipulation of information that is transmitted via the first interface unit is made at least more difficult, the operational unit is separated into a secure operational block and an insecure operation block and has only a first transmitter unit, the first interface unit being arranged in the secure operational block and the second interface unit being arranged in the insecure operational block, and the first transmitter unit is designed for transmitting first signals only from the secure operational block via a first signal path to the insecure operational block.

### BACKGROUND OF THE INVENTION

### Field of the Invention

The invention relates to an electronic device with an operational unit. The operational unit of an electronic device has a first interface unit for secure communication and a second interface unit for insecure communication.

### Description of Related Art

Such an electronic device is used, for example, in industrial systems. An industrial system normally has a plurality of facilities, such as, for example, process control systems that communicate with one another via interface units. In general, communication is the transmission of information using signals. Communication in industrial systems is thereby normally classified into secure communication, on the one hand, and insecure communication, on the other hand. In secure communication, the transmitted information is protected against manipulation, so that its integrity is ensured. This is not the case for insecure communication. Secure communication is pursued using measures that at least make manipulation of information more difficult and, in the ideal case, make it impossible. What is secure and what is insecure is left to the discretion of the operator of an industrial system, on the one hand, and to the type of industrial system, on the other hand. A general definition is not possible.

In an electronic device in an industrial system that is connected to further facilities of the industrial system, for secure communication via the first interface unit and for insecure communication via the second interface unit, the operational unit is made vulnerable due to the implementation of both the first interface unit as well as the second interface unit in the operational unit. This vulnerability often allows for manipulation with little effort via the second interface unit of information transmitted via the first interface unit, whereby the integrity of this information is compromised. Manipulated information could, for example, influence the electronic device or the further facilities of the industrial system in such a manner that the electronic device and/or the further facilities are damaged or significantly impaired during operation.

### SUMMARY OF THE INVENTION

One object of the present invention is thus to provide electronic devices, in which the manipulation of information that is transmitted via the first interface unit is made at least more difficult.

According to a first teaching, the invention is initially and essentially wherein the operational unit is separated into a secure operational block and an insecure operation block and has only a first transmitter unit. Thereby, the first interface unit is arranged in the secure operational block and the second interface unit is arranged in the insecure operational block. Furthermore, the first transmitter unit is designed for transmitting first signals only from the secure operational block via a first signal path to the insecure operational block.

The separation of the operational unit into a secure operational block and into an insecure operational block is an operational separation, wherein the understanding of secure and insecure in respect to the operational blocks is the same as in respect to the described communication. Thereby, this separation is not terminal, which is why, in addition to the secure operational block and the insecure operational block, further operational blocks can be provided in the operational unit. Thus, the first interface unit, which is used for secure communication, is assigned to the secure operational block and the second interface unit, which is used for insecure communication, is assigned to the insecure operational block. The first signal path of the first transmitter unit is the only signal path that allows for communication between the secure operational block and the insecure operational block and, namely, only from the secure operational block to the insecure operational block. Communication from the insecure operational block to the secure operational block is not implemented.

The electronic device according to the invention has the advantage, according to the first teaching, that information transmitted via the first interface unit can only be manipulated in a difficult manner via the second interface unit.

The first transmitter unit can be implemented in different manners. According to a first design of the electronic device according to the first teaching of the invention, it is provided that the first transmitter device has a first signal source for generating only the first signals and a first signal well for receiving only the first signals. Thereby, the first signal source is arranged in the secure operational block and the first signal well is arranged in the insecure operational block. Thereby, the first signal path connects the first signal source and the first signal well preferably directly to one another, so that the first signals generated by the first signal source are transmitted via the signal path to the signal well. Due to the lack of a signal well in the secure operational block and the lack of a signal source in the insecure operational block, manipulation of information that is transmitted via the first interface unit is made more difficult.

Signal sources and signal wells can also be implemented in various manners. Often, microcontrollers are already provided in electronic devices or electronic devices can be easily supplemented with microcontrollers. Thus, it is provided in a further design of the electronic device that either the first signal source is implemented by a first microcontroller and the first signal well is implemented by a second microcontroller, or that the first signal source or the first signal well is implemented by a first microcontroller. The implementation is carried out, for example, by programming the microcontroller so that often no further components are necessary. The explanations related to microcontrollers also apply to PLDs, CPLDs, FPGAs and comparable ICs. In this manner, these ICs constitute a suitable alternative to microcontrollers that are used in alternative designs.

It is, thus, appropriate to design the first transmitter unit according to a standard. In particular, these standards include UART, RS-232, EIA-485, SPI, LIN and 12C.

According to the first teaching of the invention, communication takes place between the secure operational block and the insecure operational block only in the direction from the secure operational block to the insecure operational block. However, it is often advantageous when communication is possible from the insecure operational block to the secure operational block. Thereby, it is still necessary to at least make manipulation of information that is transmitted via the first interface unit more difficult.

Thus, according to a second teaching alternative to the first teaching, the invention is initially and essentially wherein the operational unit is separated into a secure operational block and an insecure operation block and, in addition to a first transmitter unit, has only one second transmitter unit. Thereby, the first interface unit is arranged in the secure operational block and the second interface unit is arranged in the insecure operational block. Furthermore, the first transmitter unit is designed for transmitting first signals only from the secure operational block via a first signal path to the insecure operational block and the second transmitter unit is designed for transmitting second signals only from the insecure operational block via a second signal path to the secure operational block. Moreover, the second transmitter unit can be activated and deactivated, and the operational unit is designed to activate and deactivate the second transmitter unit. The formation of the operational unit for activating and deactivating the second transmitter unit is thereby arranged in the secure operational block. In one design, it is provided that the operational unit is additionally designed in the insecure operational block for activating and deactivating the second transmitter unit.

The separation of the operational unit into a secure operational block and into an insecure operational block is an operational separation, wherein the understanding of secure and insecure in respect to the operational blocks is the same as in respect to the described communication. Thereby, this separation is not terminal, which is why, in addition to the secure operational block and the insecure operational block, further operational blocks can be provided in the operational unit. Thus, the first interface unit, which is used for secure communication, is assigned to the secure operational block and the second interface unit, which is used for insecure communication, is assigned to the insecure operational block. The first signal path of the first transmitter unit and the second signal path of the second transmitter unit are the only two signal paths that allow communication between the secure operational block and the insecure operational block. Thereby, communication only from the secure operational block to the insecure operational block takes place via the first signal path and communication only from the insecure operational block to the secure operational block takes place via the second signal path.

To ensure that the manipulation of information transmitted via the first interface unit is at least made more difficult by the second interface unit, the second transmitter unit can be activated and deactivated, wherein the activation and the deactivation of the second transmitter unit is carried out by the operational unit that is accordingly designed in the secure operational block. The second transmitter unit can be either activated or deactivated. When the second transmitter unit is activated, the second signals are transmitted from the insecure operational block to the secure operational block and when the second transmitter unit is deactivated, the second signals are not transmitted from the insecure operational block to the secure operational block.

The electronic device according to the first teaching and the electronic device according to the second teaching have substantial similarities. The operational unit is separated into a secure operational block and an insecure operational block, and has a first transmitter unit according to both teachings. The first interface unit is arranged in the secure operational block and the second interface unit is arranged in the insecure operational block also according to both teachings. Furthermore, the first transmitter unit is designed, according to both teachings, for transmission of first signals only from the secure operational block via the first signal path to the insecure operational block.

The electronic device according to the second teaching has, as compared to the electronic device according to the first teaching, a second transmitter unit, wherein the second transmitter unit is designed for transmission of second signals only from the insecure operational block via a second signal path to the secure operational block. Furthermore, the second transmitter unit can be activated and deactivated, wherein the operational unit is designed in the secure block for activating and deactivating the second transmitter unit.

According to the second teaching, in addition to the advantage that information transmitted via the first interface unit can only be manipulated with difficulty via the second interface unit, the electronic device according to the invention has the further advantage that communication from the insecure operational block to the secure operational block is possible when the second transmitter device is activated by the operational unit. The activation of the second transmitter unit thereby takes place then and only as long as no manipulation can occur via the second interface unit.

Since the first transmitter unit implements only communication from the secure operational block to the insecure operational block and the second transmitter unit implements only communication from the insecure operational block to the secure operational block and the second transmitter unit can be activated and deactivated, it is ensured when the second transmitter unit is deactivated that the susceptibility for manipulation of information transmitted via the first interface unit is reduced as in the electronic device according to the first teaching.

The first transmitter unit and the second transmitter unit can be implemented in different manners. In a first design of the electronic device according to the second teaching, it is provided that, on the one hand, the first transmitter unit has a first signal source for generating only the first signals and has a first signal well for receiving only the first signals. Thereby, the first signal source is arranged in the secure operational block and the first signal well is arranged in the insecure operational block. Qn the other hand, it is provided that the second transmitter unit has a second signal source for generating only the second signals and a second signal well for receiving only the second signals, wherein the second signal source is arranged in the insecure operational block and the second signal well is arranged in the secure operational block. Thereby, the first signal path connects the first signal source and the first signal well preferably directly to one another, so that the first signals generated by the first signal source are transmitted via the first signal path to the first signal well. Accordingly, the second signal path connects the second signal source and the second signal well preferably directly to one another, so that the second signals generated by the second signal source are transmitted to the second signal well via the second signal path.

It is appropriate to design the first transmitter unit and/or the second transmitter unit according to a standard. In particular, these standards include UART, RS-232, EIA-485, SPI, LIN, I2C.

Signal sources and signal wells can be implemented in various manners. Thus, it is provided in a further design of the electronic device according to the second teaching that the first signal source and/or the second signal well is/are implemented by at least one first microcontroller and/or that the second signal source and/or the first signal well is/are implemented by at least a second microcontroller. Preferably, the first signal source and the second signal well are implemented by a first microcontroller and the second signal source and the first signal well are implemented by a second microcontroller, which contributes to a particularly economical implementation, since only two microcontrollers are required. Thereby, the at least one first microcontroller, which implements the first signal source and/or the second signal well, is arranged in the secure operational block and the at least one second microcontroller, which implements the second signal source and/or the first signal well, is arranged in the insecure operational block.

In order to ensure that information that is transmitted via the first interface unit can only be manipulated with difficulty using the second interface unit, the second transmitter device can be designed to be activated and deactivated. The ability to activate and deactivate the second transmitter unit can be implemented in various manners. In a first design, it is provided that the second transmitter unit can be activated and deactivated by a switch in the second signal path. The switch is thereby activated and deactivated by the operational unit, for which the operational unit is accordingly designed in the secure operational block. When the second signal path is an electrical signal path, an electric switch, for example, can be used as switch that interrupts the second signal path when the second transmitter unit is deactivated and does not interrupt the second signal path when the second transmitter unit is activated.

In an additional or alternative design to the above design, it is provided that the second transmitter unit can be activated or deactivated by activating or deactivating the second signal source and/or the second signal well. This design is, in particular, advantageous when the second signal source is implemented by a microcontroller and/or the second signal well is implemented by a microcontroller. Microcontrollers generally have freely configurable ports that can be configured both as signal source as well as signal well by programming the microcontroller. Furthermore, microcontrollers often implement standards such as UART. Thus, it is possible to activate or deactivate the second signal source and/or the second signal well in that a freely-configurable port of a microcontroller is activated or deactivated or in that the UART is activated or deactivated. Normally, a UART also has an input buffer. Then, the second signal well can also be deactivated by not reading the input buffer. Accordingly, the second signal well is activated by reading the input buffer. This implementation is carried out entirely using programming.

In a further design of the electronic device according to both the first and the second teachings, it is provided that the electrical device is a field device. Field devices are electronic devices in the field of automation and process technology, which are in direct contact to a process.

It is provided in a further design that the operation unit has a measuring unit and the measuring unit is assigned to the secure operational block. The assignment of the measuring unit to the secure operational block means that communication with the measuring unit is only possible via the secure operational block, whereby it is ensured that measurement data determined by the measuring unit is protected against manipulation.

In order to reduce the number of wired transmission media, it is provided in a further design that the first interface unit and the second interface unit are designed for connection to the same wired transmission medium and for simultaneous secure communication and insecure communication. The simultaneous transmission of information via the first interface unit and the second interface unit and via the same wired transmission medium requires that the signals, which are simultaneously transmitted via the first interface and the second interface and which contain the information, can be differentiated from one another.

It is provided in a further design that the first interface unit is designed only for unidirectional secure communication starting at the first interface unit. Thus, no communication into the secure operational block is possible via the first interface unit, whereby manipulation is made more difficult.

It is provided in a further design that the second interface unit is designed for bidirectional insecure communication.

In detail, there is a plurality of possibilities for designing and further developing the electronic device according to the invention as will be apparent from the following description of preferred embodiments in conjunction with the drawings.

### BRIEF DESCRIPTION OF THE DRAWINGS

FIG. 1 shows a first embodiment of an electronic device and

FIG. 2 shows a second embodiment of an electronic device.

### DETAILED DESCRIPTION OF THE INVENTION

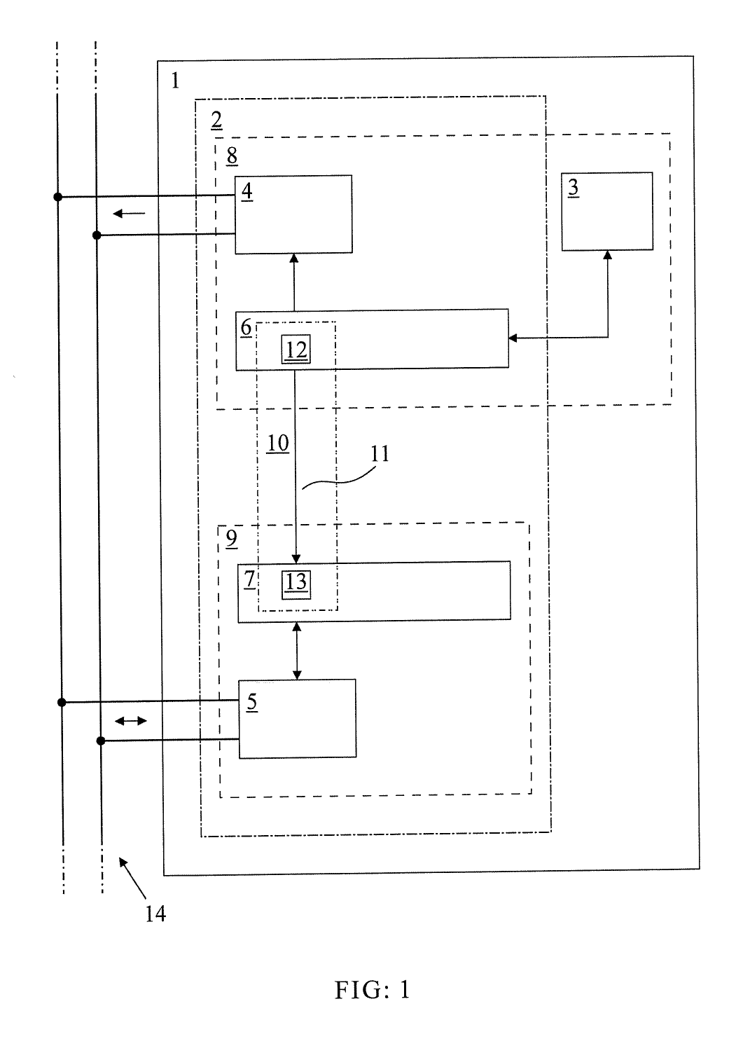

FIG. 1 shows a first embodiment of the electronic device 1 in an abstract, schematic representation, wherein the electronic device 1 is designed as a field device in this embodiment. The electronic device 1 has the operational unit 2 and the measuring unit 3.

The operational unit 2 has the first interface unit 4 for secure communication, the second interface unit 5 for insecure communication, the first microcontroller 6 and the second microcontroller 7. The operational unit 2 is separated into the secure operational block 8 and the insecure operation block 9. The first interface unit 4 and the first microcontroller 6 are arranged in the secure operational block 8 and the measuring unit 3 is assigned to the secure operational block 8, which is possible because the separation into a secure operational block 8 and an insecure operation block 9 is an operational separation. The second interface unit 5 and the second microcontroller 7 are, on the other hand, arranged in the insecure operational block 9.

Furthermore, the operational unit 2 has only the first transmitter unit 10, wherein the first transmitter unit 10 is designed for transmitting first signals only from the secure operational block 8 via the first signal path 11 to the insecure operational block 9.

Additionally, the first transmitter unit 10 has, in addition to the first signal path 11, the first signal source 12 for generating only the first signals and the first signal well 13 for only receiving the first signals. The first signal source 12, is thereby implemented in the first microcontroller 6 and, thus, in the secure operational block 8 and the first signal well 13 is implemented in the second microcontroller 7 and, thus, in the insecure operational block 9. The first microcontroller 6 and the second microcontroller 7 are thereby designed such that the first signal source 12 and the first signal well 13 are a UART (universal asynchronous receiver transmitter), in which the first signals are only transmitted from the secure operational block 8 via the first signal path 11 to the insecure operational block 9. The first microcontroller 6 and the second microcontroller 7 are not designed so that a transmission of signals is possible from the insecure operational block 9 to the secure operational block 8.

The first interface unit 4 and the second interface unit 5 are designed for connection to the same wired transmitter medium 14 and for simultaneous secure and insecure communication. Thereby, secure communication takes place only via the first interface unit 4 and insecure communication takes place only via the second interface unit 5. In the present embodiment, the wired transmitter medium 14 is a bus with two wires, to which both the first interface unit 4 and the second interface unit 5 are electrically connected. The first interface unit 4 is thereby designed only for unidirectional secure communication starting at the first interface unit 4 and the second interface unit 5 is designed for bidirectional insecure communication. Since, during operation of the electronic device 1, secure communication takes place only unidirectionally starting at the first interface unit 4 and the first signals are transmitted only from the secure operational block 8 to the insecure operational block 9, the secure operational block 8 is protected against manipulation that could influence the integrity.

During operation of the electronic device 1, measurements controlled by the first microcontroller 6 from the measuring unit 3 are carried out and measurement data is detected. The detected measurement data is transmitted unidirectionally through the first interface unit 4 to the wired transmitter medium 14. For this, the first interface unit 4 in this embodiment implements a current interface and transmits the measurement data encoded by a current strength between 4 mA and 20 mA to the wired medium 14.

Furthermore, the first microcontroller 6 determines status data from the measurements and transmits this data via the first transmitter unit 10 to the second microcontroller 7. The second microcontroller 7 transmits the status data to the second interface unit 5 and the second interface unit 5 transmits the status data, in this embodiment, according to HART (highway addressable remote transducer) to the wired transmitter medium 14. Furthermore, data is also transmitted via the wired transmitter medium 14 and the second interface unit 5 to the second microcontroller 7. However, there is no technical possibility for this data to reach the first microcontroller 6 from the second microcontroller 7.

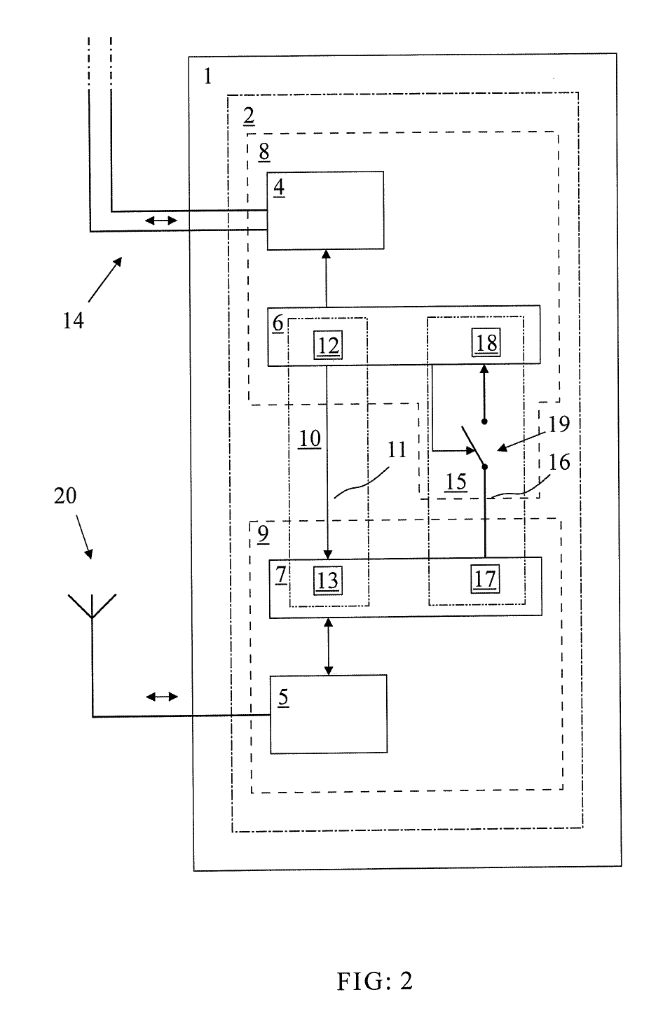

FIG. 2 shows a second embodiment of the electronic device 1 in an abstract, schematic representation, wherein the electronic device 1 is designed as an interface device in this embodiment.

The electronic device 1 has the operational unit 2. The operational unit 2 has the first interface unit 4 for secure communication, the second interface unit 5 for insecure communication, the first microcontroller 6 and the second microcontroller 7. The operational unit 2 is separated into the secure operational block 8 and the insecure operational block 9. This first interface unit 4 and the first microcontroller 6 are arranged in the secure operational block 8 and the second interface unit 5 and the second microcontroller 7 are arranged, on the other hand, in the insecure operational block 9.

Moreover, the operational unit 2, in addition to a first transmitter unit 10, has only one second transmitter unit 15, wherein the second transmitter unit 15 can be activated and deactivated, and the operational unit 2 is designed to activate and deactivate the second transmitter unit 15. Thereby, the first transmitter unit 10 is designed for transmitting first signals only from the secure operational block 8 via the first electric signal path 11 to the insecure operational block 9 and the second transmitter unit 15 is designed for transmitting second signals only from the insecure operational block 9 via the second electric signal path 16 to the secure operational block 8.

In addition to the first signal path 11, the first transmitter unit 10 has the first signal source 12 for generating only the first signals and the first signal well 13 for receiving only the first signals. In addition to the second signal path 16, the second transmitter unit 15 has the second signal source 17 for generating only the second signals and the second signal well 18 for receiving only the second signals.

Furthermore, the operational unit 2 has the electric switch 19, which is arranged in the second signal path 16 and in the secure operational block 8. The switch 19 is activated and deactivated during operation of the electronic device 1 by the first microcontroller 6 of the operational unit 2, for which the first microcontroller 6 is accordingly designed. When the first microcontroller 6 controls the switch 19 so that the switch 19 is open, the second signal path 16 is interrupted and the second transmitter unit 15 is, thus, deactivated. When the first microcontroller 6 controls the switch 19 so that the switch is closed, the second signal path 16 is not interrupted and, thus, the second transmitter unit 15 is activated.

The first signal source 12 and the second signal well 18 are implemented in the first microcontroller 6 and, thus, in the secure operational block 8 and the first signal well 13 and the second signal source 17 are implemented in the second microcontroller 7 and, thus, in the insecure operational block 9. The first microcontroller 6 and the second microcontroller 7 are thereby designed such that the first signal source 12 and the first signal well 13 are a UART (universal asynchronous receiver transmitter), in which the first signals are transmitted only from the secure operational block 8 to the insecure operational block 9. Furthermore, the first microcontroller 6 and the second microcontroller 7 are designed such that the signal source 17 and the signal well 18 are a UART (universal asynchronous receiver transmitter), in which the second signal is transmitted only from the insecure operational block 9 via the second signal path 16 to the insecure operational block 8 when the switch 19 is closed.

The first interface unit 4 and the second interface unit 5 are designed for simultaneous secure communication and insecure communication. Thereby, the secure communication is carried out only via the first interface unit 4 and the insecure communication is carried out only via the second interface unit 5. In the present embodiment, the wired transmitter medium 14 is a bus with two wires, to which only the first interface unit 4 is electrically connected. Communication takes place, for example, bidirectionally using HART with a process control system via the first interface unit 4. In this embodiment, the second interface unit 5 has a wireless module 20 and also communicates bidirectionally with a remote station using WLAN. Due to the separation into a secure operational block 8 and an insecure operational block 9 and the described transmission of first and second signals between the secure operational block 8 and the insecure operational block 9, the electronic device 1 designed as interface device ensures that the process control system connected to the first interface unit 4 is assigned to the secure operational block 8, as is the case with the measuring unit 3 from the first embodiment. Thus, the same advantages arise as with the measuring unit 3.

The communication via the first interface 4 and the second interface 5 can be implemented using different standards. These standards include standards for field buses (HART, CAN, Foundation Fieldbus, Profibus), standards for wireless transmission (WLAN, Bluetooth, Zigbee, wireless HART), standards for wired interfaces (ethernet, etherCAT) and further standards such as LIN, SPI UART, current loop (4 mA to 20 mA).

What is claimed is:

1. An electronic device with an operational unit, wherein the operational unit has a first interface unit for secure communication and a second interface unit for insecure communication,
wherein the operational unit is separated into a secure operational block and an insecure operation block and has only a first transmitter unit,
wherein the first interface unit is arranged in the secure operational block and the second interface unit is arranged in the insecure operational block, and
wherein the first transmitter unit is adapted for transmitting first signals only from the secure operational block via a first signal path to the insecure operational block.

2. The electronic device according to claim 1, wherein the first transmitter unit has a first signal source for generating only the first signals and a first signal well for receiving only the first signals, wherein the first signal source is arranged in the secure operational block and the first signal well is arranged in the insecure operational block.

3. The electronic device according to claim 2, wherein the first signal source is implemented by a first microcontroller and the first signal well is implemented by a second microcontroller.

4. Electronic device with an operational unit, wherein the operational unit has a first interface unit for secure communication and a second interface unit for insecure communication,
wherein the operational unit is separated into a secure operational block and an insecure operation block and
wherein the operational unit has only a first transmitter unit and one second transmitter unit,
wherein the first interface unit is arranged in the secure operational block and the second interface unit is arranged in the insecure operational block,
wherein the first transmitter unit is adapted for transmitting first signals only from the secure operational block via a first signal path to the insecure operational block and the second transmitter unit is adapted for transmitting second signals only from the insecure operational block via a second signal path to the secure operational block, and
wherein the second transmitter unit is activatable and deactivatable, and wherein the operational unit in the secure operational block is adapted to activate and deactivate the second transmitter unit.

5. The electronic device according to claim 4, wherein the operational unit in the insecure operational block is adapted to activate and deactivate the second transmitter unit.

6. The electronic device according to claim 4, wherein the first transmitter unit has a first signal source for generating only the first signals and has a first signal well for receiving only the first signals, wherein the first signal source is arranged in the secure operational block and the first signal well is arranged in the insecure operational block, wherein the second transmitter unit has a second signal source for generating only the second signals and a second signal well for receiving only the second signals, and wherein the second signal source is arranged in the insecure operational block and the second signal well is arranged in the secure operational block.

7. The electronic device according to claim 6, wherein at least one of the first signal source and the second signal well is implemented by at least one first microcontroller

8. The electronic device according to claim 7, wherein at least one of the second signal source and the first signal well is implemented by at least a second microcontroller.

9. The electronic device according to claim 6, wherein at least one of the second signal source and the first signal well is implemented by at least a second microcontroller.

10. Electronic device according to claim 4, wherein the second transmitter unit is activatable or deactivatable by a switch in the second signal path.

11. Electronic device according to claim 4, wherein the second transmitter unit activatable or deactivatable by activating or deactivating at least one of the second signal source and the second signal well.

12. Electronic device according to claim 1, wherein the electronic device is a field device.

13. Electronic device according to claim 1, wherein the electronic device has a measuring unit and the measuring unit is assigned to the secure operational block.

14. Electronic device according to claim 1, wherein the first interface unit and the second interface unit have means for connection to the same wired transmitter medium and for simultaneous secure communication and insecure communication.

15. Electronic device according to claim 1, wherein the first interface unit is constructed for only unidirectional secure communication starting at the first interface unit.

16. Electronic device according to claim 1, wherein the second interface unit is adapted for bidirectional insecure communication.
